(19) United States
(12) Patent Application Publication
(10) Pub. No.: US 2005/0081367 A1
(43) Pub. Date: Apr. 21, 2005

(54) Method of manufacturing a media reference surface for use in a flexible data storage card

(76) Inventors: Geoffrey A. Lauinger, Campbell, MN (US); Kellan D. Pauly, Wahpeton, ND (US); Anthony O. Banal, Fergus Falls, MN (US)

Correspondence Address: Imation Corp., PO Box 64898, St. Paul, MA, 55164-0898, US

(21) Appl. No.: 10/690,439

(22) Filed: Oct. 21, 2003

(51) Int. Cl. G06K 19/06

(52) U.S. Cl. 29/603.01; 29/604; 235/492; 29/603.03

(57) ABSTRACT

A method of manufacturing media reference surfaces for use in a flexible data storage card is described that includes providing a metal sheet and processing the metal sheet into a plurality of media reference surfaces. The metal sheet has a first side and a second side, where at least one side has an optically smooth surface characterized by an average surface roughness not greater than 8 micro-inch. Each media reference surface is characterized by having at least one curved edge adjacent the optically smooth surface. The processing is characterized by an absence of hand polishing.

### THE FIELD OF THE INVENTION

The present invention relates to flexible data storage cards. More particularly, it relates to a method of manufacturing media reference surfaces for use in a flexible data storage card such as a StorCard® flexible data storage card.

### BACKGROUND OF THE INVENTION

Data storage media have been used for decades in the computer, audio, and video fields. Data storage media continue to be employed for storing large volumes of information in a form suited for subsequent retrieval and use.

Data storage media are generally provided in one of two forms, long strands of tape and rotating discs. The rotating disc data storage media are generally of two types: hard disc (HD) media and floppy disc (FD) media. Generally, HD media are maintained within a housing of a data storage device and is associated with a drive, neither of which is removable from the housing. For example, HD media are commonly maintained within a computer hard drive and accessed via an internal read/write device of the drive. In contrast, FD media are removable from, and interchangeable between, data storage devices. In this regard, FD media have the benefit of being transportable. Typically, a shutter is provided on an exterior portion of the FD to cover and protect the FD media during periods of inactivity and to permit the read/write device to access the FD media during use.

HD media employ rigid discs formed of a metal substrate and include a sputter deposition of a magnetic film. Deposition of the magnetic media in this manner permits a very high magnetic recording density to be achieved. During a read/write operation, the HD media are rotated at high speeds and “fly” over the read/write head in a non-contact manner. In contrast, the FD media are composed of a plastic substrate, such as Mylar®, which is coated with a slurry of magnetic particles. In this regard, FD media operate at low speeds and the read/write head contacts the recording medium. To facilitate good wear characteristics, the magnetic slurry contains a binder and a bulk lubricant along with the magnetic particles. Regardless, FD media is typically provided to users in an industry-accepted format, such as 3.5 inch floppy discs. While universally accepted, these formats are not conducive to convenient handling and carrying by users, have limited storage capacity, and do not provide rigorous protection for the FD media.

More recently, efforts have been made to provide a conveniently sized, robust FD-type media. In particular, flexible media are fabricated into a disc and placed within a transportable card having a form factor of approximately that of a credit card. Such a device is known as a “flexible data storage card” and has mechanical flexibility in both the longitudinal and transverse directions. A flexible data storage card described by StorCard, Inc., San Jose, Calif. under the trademark StorCard® is one example. Generally, the StorCard® flexible data storage card consists of an outer shell or housing that maintains the flexible media disc. The housing normally includes a separate cover and a separate base that encloses the flexible media, fabric liners, and other components. The cover is known as a card top and is formed of a plastic laminate and includes an integrated circuit that monitors the flow of data into, and out of, the flexible storage card. The base is a thin metallic structure that is laminated to the card top to form the housing structure. A window is provided on the base and includes a shutter that provides selective access to the flexible media disc by an external read/write head.

During use, the shutter in the base is displaced to provide access to the flexible media disc by the read/write head. The flexible media disc rotates at approximately 3600 rotations per minute (rpm) thereby attaining a high velocity at the edge of the disc. The high velocity of the rotating disc is desirable and creates an “air bearing” between the flexible media disc and the read/write head. In this regard, the read/write head is said to “fly” over the flexible media disc. The air bearing is comprised of aerodynamic forces that can be controlled to ensure that the read/write head does not “crash” into the flexible media disc, as such contact could lead to catastrophic damage to the flexible media disc and the data stored thereon. To assist in the positioning of the read/write head and the flexible media disc, a media reference surface is provided on the interior side of the card top in a position opposite the shutter/window of the base (i.e., opposite of the read/write head).

The media reference surface is generally an elongated piece of non-magnetic metal attached to the card top interior. In particular, the media reference surface is situated adjacent the side of the flexible media that is not coated with magnetic media. Positioned in this manner, the flexible media disc “flies” between the read/write head and the media reference surface during a read/write operation such that air bearings are formed between both the read/write head and the disc and the media reference surface and the disc. Consequently, the side of the media reference surface exposed to the disc must have a very smooth surface topography to ensure that the air bearings are not disturbed. Additionally, because the disc flies over the media reference surface, the leading edge of the media reference surface is preferably rounded, or curved, to avoid the possibility of the media reference surface cutting into, or skiving, the disc.

Prior art media reference surfaces, and in particular those associated with StorCard® products, are first formed to the desired size and then the exposed surface (i.e., the disc side) is polished by hand. During polishing, the leading edge of the media reference surface is rounded. This high polish finish is characterized by an average surface roughness (Rₐ) as measured in micro-inches. Typically, the media reference surface will have an Rₐ of not greater than 8.0 micro-inch and a rounded leading edge having a radius of curvature on the order of 0.005 inch. These surface features are carefully crafted onto each prior art media reference surface consuming large spans of time. Accordingly, the known media reference surfaces are hand finished and are characterized by a low throughput rate that is associated with one-piece-at-a-time hand finishing. As such, the media reference surface component of a StorCard® flexible data storage card, or other flexible data storage card, has a comparatively high component cost and limits the production rate of these data storage devices. For these reasons, a need exists for a method of manufacturing media reference surfaces without hand polishing.

### SUMMARY OF THE INVENTION

One aspect of the present invention relates to a method of manufacturing media reference surfaces for use in a flexible data storage card. The method includes providing a metal sheet having a first side and a second side, at least one side having an optically smooth surface characterized by an average surface roughness not greater than 8 micro-inch. The method additionally includes processing the metal sheet into a plurality of media reference surfaces such that each media reference surface has at least one curved edge adjacent the optically smooth surface. In this regard, the processing is characterized by the absence of hand polishing.

An additional aspect of the present invention relates to another method of manufacturing a media reference surface for use in a flexible data storage card. This method includes providing a source of metal sheeting, the metal sheeting having a first side and a second side, at least one side having an optically smooth surface. The method additionally includes shearing the metal sheeting with a die and a punch to form the media reference surfaces such that each media reference surface has a leading edge and a trailing edge. The shearing is configured to die roll at least the leading edge.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective, exploded view of a simplified flexible data storage card;

FIG. 2 is a perspective view of an underside of the card top of FIG. 1 showing a media reference surface;

FIG. 3 is a perspective view of the media reference surface of FIG. 2;

FIG. 4 is a cross-sectional view of the media reference surface of FIG. 3 showing read/write head and a media pathway above the media reference surface;

FIG. 5 is a schematic illustration of a process for manufacturing a plurality of media reference surfaces according to one embodiment of the present invention;

FIG. 6A is a schematic illustration of another process for manufacturing a plurality of media reference surfaces conjoined by attachment edges according to one embodiment of the present invention;

FIG. 6B is a perspective view of a processed strip of conjoined media reference surfaces in accordance with the present invention;

FIG. 7 is a perspective view of a metal sheet prepared for a photo-etching process according to one embodiment of the present invention; and

FIG. 8 is a cross-sectional view of the metal sheet of FIG. 7 showing a plurality of media reference surfaces after a photo-etching process.

### DETAILED DESCRIPTION OF THE PREFERRED EMBODIMENTS

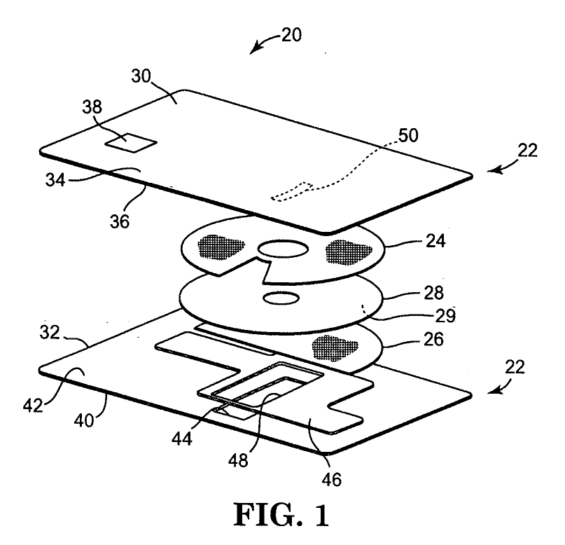

The present invention relates to a method of fabricating a media reference surface for use in a flexible data storage card. To this end, an example of a simplified flexible data storage card as advertised under the trademark StorCard® is illustrated at 20 in FIG. 1. The StorCard® flexible data storage card 20 offered by StorCard, Inc., San Jose, Calif., includes a housing 22, a first wiping pad 24, a second wiping pad 26, and a flexible media disc 28. The flexible media disc 28 is coated on a media side 29 with a magnetic media: When assembled, the flexible media disc 28 is rotatably disposed within the housing 22. Notably, the flexible data storage card 20 of FIG. 1 is but one example of an acceptable configuration with which the present invention is useful. That is to say, the present invention can be employed in conjunction with other flexible data storage card designs that may or may not be offered by StorCard, Inc., and can include additional features and/or components not otherwise illustrated in FIG. 1.

The housing 22 is sized to be transportable and have a form factor that approximates the size of a credit card. Thus, the housing 22 has a size of approximately 86 mm×54 mm×0.8 mm, although other dimensions are acceptable. With this in mind, the housing is defined by a card top 30 and a base 32. In one embodiment, the card top 30 forms a cover whereas the base 32 forms a bottom. As used throughout the specification, directional terminology such as “cover,” “base,” “upper,” “lower,” “top,” “bottom,” etc., is employed for purposes of illustration only and is in no way limiting.

The card top 30 and the base 32 are sized to be reciprocally mated to one another and are generally rectangular. The card top 30 defines an exterior surface 34 and an interior surface 36. An electronic chip 38 is mounted to the card top 30 exterior surface 34 and controls the flow of data to and from the flexible data storage card 20. In a similar fashion, the base 32 defines an outer surface 40 and an inner surface 42. The card top 30 is generally formed of a thin laminate of plastic and metal layers. The base 32 is generally formed of thin metallic layers secured to each another. As an example, the card top 30 and the base 32 can each be formed from two layers, the layers having a thickness of about 0.003 inch, such that the card top 30 and the base 32 are flexible. After assembly, the flexible data storage card 20 is transportable, for example, in a wallet, and can be flexed in both the transverse and longitudinal directions without damage to the disc 28.

Additionally, an access window 44 is formed in the base 32 to permit access by a read/write head (not shown) to the media side 29 of the flexible media disc 28. In particular, a shutter 46 is provided on the inner surface 42 and has a shutter window 48 that is configured to permit selective access by the read/write head to the media side 29 of disc 28 when at least partially aligned with the access window 44.

During a read/write operation, the shutter 46 is displaced and the read/write head (not shown) enters the housing 22 via the access window 44 and the shutter window 48. The flexible media disc 28 rotates at approximately 3600 rpm a small distance above the read/write head without contacting the read/write head. In this regard, the flexible media disc 28 is said to “fly” above the read/write head. The high rotational rate of the flexible media disc 28 creates an air bearing between the flexible media disc 28 and the read/write head. To ensure accurate and reproducible reading and writing by the read/write head, a media reference surface 50 is provided on the interior surface 36 of the card top 30. The media reference surface 50 is positioned opposite the read/write head and opposite the media side 29 of disc 28. In this way, the spinning flexible media disc 28 is constrained to a reference position between the read/write head and the media reference surface 50.

The first wiping pad 24 and the second wiping pad 26 are of a type known in the art and are generally characterized as soft fibrous sheets that are configured to capture dust and debris generated when the flexible media disc 28 rotates between the wiping pads 24, 26. The wiping pads 24, 26 can be either woven or non-woven fibrous pads that are preferably formed to be non-linting. In addition, the wiping pads 24, 26 are configured so as not to obstruct the interaction between the flexible media disk 28 and the media reference surface 50.

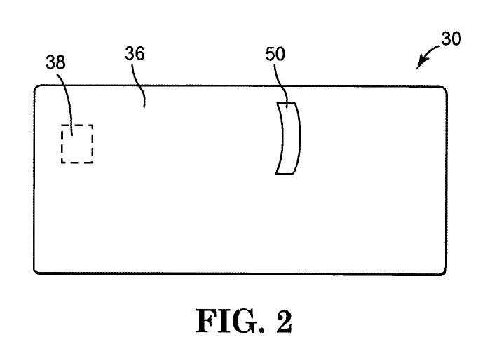

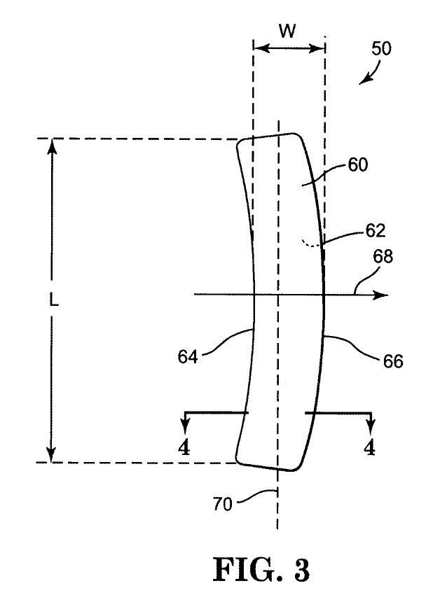

The flexible media disc 28 (hereinafter media disc 28) is of a type known in the art and generally includes a thin sheet of polyester or similar material that is coated with a magnetic slurry on the media side 29. For example, the thin sheet of polyester is approximately 0.003 inch thick and includes a slurry coated layer of magnetic particles. A bottom view of the interior surface 36 of the card top 30 is illustrated in FIG. 2. Specifically, the card top 30 has been removed and inverted to display the interior surface 36. Attached to the interior surface 36 is the media reference surface 50. Note that after assembly, the media reference surface 50 is positioned opposite the shutter window 48 (FIG. 1). Consequently, when the read/write head (not shown) projects through the shutter window 48 and traverses a longitudinal path through the shutter window 48 over the media disc 28, the media reference surface 50 is positioned to serve as a backstop, or reference plane, for the entire longitudinal path of the read/write head. To better describe its attributes, the media reference surface 50 is illustrated in FIG. 3 in an enlarged form apart from the card top 30.

The media reference surface 50 defines an exposed surface 60 and an attachment surface 62. The attachment surface 62 is in contact with the interior surface 36 of the card top 30 (FIG. 2). Additionally, the media reference surface 50 defines a leading edge 64 and a trailing edge 66. During use, the media disc 28 (FIG. 1) flies over the exposed surface 60 and defines a media pathway 68 over the media reference surface 50. Accordingly, the media pathway 68 traverses the media reference surface 50 from the leading edge 64 to the trailing edge 66. As the media disc 28 (FIG. 1) is accessed by a read/write head (not shown), the read/write head traverses a longitudinal path 70 over the media reference surface 50 as demarcated in FIG. 3. In this manner, the media reference surface 50 forms a backstop, or reference plane, that is configured to stabilize and position the media disc 28 for interaction with the read/write head. For this reason, the media reference surface 50 is also known as a “head zero”. Further, the media reference surface 50 has associated with it a length L and a width W. In one example, the length L is approximately 0.5 inch. The width W is selected so as to provide adequate clearance for the read/write head as it traverses the longitudinal path 70. Accordingly, in one example, the width W is approximately 0.10 inch. Generally, the media reference surface 50 is formed of a non-magnetic material (such as stainless steel) and has a thickness of approximately 0.007 inch.

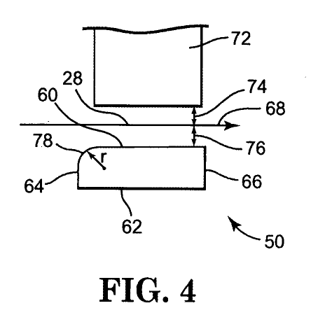

FIG. 4 is a cross-sectional view of the media reference surface 50 of FIG. 3 with a read/write head 72 illustrated for descriptive clarity. As discussed, the media reference surface 50 has the exposed surface 60 above which the media disc 28 flies defining the media pathway 68. The high rotational speed of the media disc 28 through the media pathway 68 forms a first air bearing 74 between the media disc 28 and the read/write head 72 and a second air bearing 76 between the media disc 28 and the media reference surface 50. The air bearings 74, 76 are cushions of air that the media disc 28 “rides” upon. It is desired that the media pathway 68 have as little horizontal variation as possible to ensure accurate reading and writing of the data stored on the media disc 28. Therefore, the exposed surface 60 is a highly polished surface such that the air bearings 74, 76 are uniformly and predictably formed. If the exposed surface 60 is marked by surface defects, the surface defects interrupt the air bearings 74, 76 and cause the media pathway 68 to deviate perpendicularly to the media reference surface 50. Therefore, the exposed surface 60 should be a highly smooth surface, preferably an optically smooth surface, characterized by an average surface roughness (Rₐ) of not greater than 8 micro-inch, more preferably not greater than 5 micro-inch. Notably, if the media disc 28 deviates perpendicular to the media reference surface 50, the media pathway 68 could potentially intersect the media reference surface 50 at the leading edge 64, thereby skiving a surface of the media disc 28. For this reason, the leading edge 64 includes a rounded edge 78 with a curvature defined by a radius r in the range of 0.001-0.007 inch.

The media reference surface 50 is characterized by the desired optically smooth exposed surface 60 and the rounded edge 78 formed at the leading edge 64. The prior art media reference surfaces have been produced one-at-a-time and require various hand polishing steps to achieve the optically smooth surface 60 and rounded leading edge 78. As constrained by the prior art method of manufacture, the prior art media references surfaces are essentially custom crafted parts characterized by low part throughput and high part cost. As a general practice, the prior art media reference surfaces are first formed to a desired shape and then painstakingly polished and sized throughout various handling operations to achieve the smooth exposed surface and the rounded leading edge. Accordingly, the prior art method of manufacturing media reference surfaces is not suited to high volume production of flexible data storage cards. In contrast to the prior art method for making media reference surfaces, a novel process for manufacturing media reference surfaces accurately and inexpensively has been developed. This new method of manufacturing media reference surfaces, described below, enables rapid production of media reference surfaces without hand polishing.

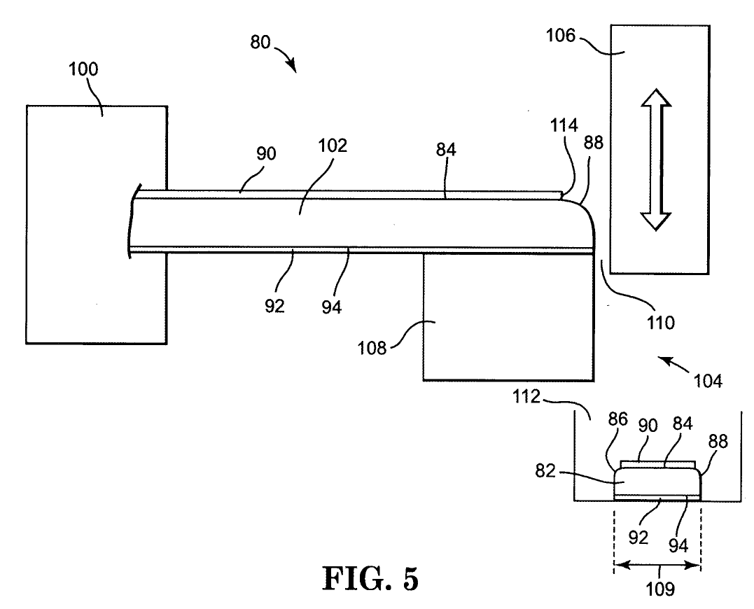

An exemplary method of manufacturing a media reference surface according to one embodiment of the present invention is schematically illustrated at 80 in FIG. 5. The output of process 80 is a plurality of media reference surfaces 82, also known as head zeros, having an optically smooth surface 84 and a curved leading edge 86. In another embodiment, the media reference surface 82 includes a protective coating 90 applied to the optically smooth surface 84 to protect the optically smooth surface 84 throughout the processing steps. Optionally, a second coating 92 is provided and contacts an attachment surface 94 defined opposite the optically smooth surface 84. In a preferred embodiment, the coatings 90, 92 are a liner attached to the respective surfaces 84, 94. In an alternate embodiment, the coatings 90, 92 are an epoxy attached to the respective surfaces 84, 94. Regardless, the coatings 90, 92 are removed prior to attachment of the media reference surface 82 to the card top 30 (FIG. 2).

In one exemplary embodiment, the process 80 for manufacturing a plurality of media reference surfaces 82 is as follows. A container 100 provides a source of continuous metal sheeting 102 that is fed into a forming apparatus 104. The metal sheeting 102 is selected to have a width that corresponds to a length of the completed media reference surfaces 82. As oriented in FIG. 5, the width of the metal sheeting 102 is a dimension into the page. In one embodiment, the width of the metal sheeting is approximately 0.30 inch to 0.70 inch, more preferably the width is 0.40 inch to 0.60 inch, and most preferably, the width is approximately 0.53 inch. That is to say, the length of the completed media reference surface 82 has a length of approximately 0.30 inch to 0.70 inch, more preferably the length is 0.40 inch to 0.60 inch, and most preferably, the length is approximately 0.53 inch.

The forming apparatus 104 includes a punch 106 and a die 108. The die 108 positions the metal sheeting 102 such that with each cycle of the punch 106, a single one of the media reference surfaces 82 is produced. After each cycle of the punch 106, the metal sheeting is indexed a distance corresponding to one part width 109, such that the next media reference surface 82 is positioned for formation. The width 109 is selected to provide adequate clearance for the read/write head 72 (FIG. 4) as it traverses the longitudinal path 70 (FIG. 3). Accordingly, in one embodiment, the width 109 has a range of approximately 0.050 inch to 0.250 inch, more preferably the width 109 has a range of between 0.075 inch to 0.175 inch, and most preferably, the width 109 is approximately is 0.10 inch. In this manner, a plurality of media reference surfaces 82 can be manufactured without hand polishing any portion of the media reference surface 82.

The metal sheeting 102 is configured to provide the optically smooth surface 84 and the attachment surface 94. For example, the metal sheeting 102 can be mechanically treated and/or polished such that at least one side is optically smooth. Specifically, where one side of the metal sheeting 102 is polished to have an average surface roughness Rₐ not greater than 8 micro-inch, the edges of the metal sheeting 102 will be nearly razor sharp. Accordingly, the metal 102 sheeting provides a highly polished surface but is in itself not suited for use as a media reference surface 82 due to sharp edges. In a preferred embodiment, the metal sheeting 102 is a non-magnetic material (such as stainless steel) and has a thickness of approximately 0.007 inch.

As illustrated in FIG. 5, in one embodiment, the protective coatings 90, 92 protect the optically smooth surface 84 and the attachment surface 94, respectively. In a preferred embodiment, the optically smooth surface 84 has an average surface roughness Rₐ not greater than 8 micro-inch and is protectively covered by liner 90. During the formation process, the punch 106 moves vertically to shear the metal sheeting 102 which is held in place by the die 108. A gap 110 is provided between the punch 106 and the die 108 and is configured to create a die roll on at least the leading edge 86 and to provide a sufficient clearance such that the media reference surface 82 is sheared cleanly (i.e., without a burr on either the leading edge 86 or the trailing edge 88). The die roll that is formed by the shearing action of the forming apparatus creates the radius of curvature at the leading edge 86. The curvature created by the die roll depends on the material properties of the metal sheeting 102 and the gap 110.

The gap 110 is selected based upon the desired curvature at the leading edge 86. In particular, the die roll is effectuated as the punch 106 moves vertically in relationship to the die 108 such that the metal sheeting 102 is sheared in a manner that causes the metal sheeting 102 to mechanically yield before the metal sheeting 102 fractures, thus resulting in the formation of the curved edges 86, 88. In this manner, the curved edges 86, 88 are formed by die rolling via the interaction of the punch 106 and the die 108. Accordingly, if the gap 110 is large, then the curved edges 86, 88 acquire a large radius of curvature. Conversely, if the gap 110 is small, the radius of curvature of the curved edges 86, 88 is small. Therefore, it is desired to maintain a gap 110 that results in a radius of curvature on the curved edges 86, 88 in the range of 0.001-0.007 inch. In this regard, the gap 110 spacing is in the range of 0.005 inch to 0.0001 inch, more preferably the gap 110 spacing is between 0.003 inch and 0.0003 inch, even more preferably the gap 110 spacing is between 0.002 inch and 0.0005 inch, and most preferably the gap 110 is approximately 0.001 inch.

With each cycle of the punch 106, a media reference surface 82 is formed having the curved leading edge 86. As the plurality of media reference surfaces 82 are formed, a receptacle 112 is positioned to receive the finished parts. At the completion of one full process cycle of the punch 106, the curved trailing edge 88 is again positioned adjacent the punch 106. In this way, the metal sheeting 102 is indexed into the punch 106 and the die 108 such that the curved leading edge 86 and the curved trailing edge 88 are formed with each cycle of the punch 106. During formation of the curved edges 86, 88, the protective liner 90 is torn at a forward edge 112.

With regard to the process illustrated in FIG. 5, it is preferred that the metal sheeting 102 is provided in a continuous form. For example, the length of the metal sheeting 102 should be sufficient to permit the formation of a plurality of media reference surfaces 82. In one embodiment, the metal sheeting 102 is provided as a rolled coil prior to processing, with the liner(s) 90, 92 serving to protect the optically smooth surface 84 from contacting the attachment surface 94. Regardless, and in a preferred embodiment, the metal sheeting 102 has a length that is at least approximately a factor of ten greater than the width 109 of the media reference surface 82. For example, where the width 109 is approximately 0.010 inch, then for every one-inch segment, for example, approximately ten media reference surfaces 82 can be produced from that segment. Accordingly, in one embodiment, the length of the coiled metal sheeting 102 is selected to be approximately 36 inches.

As noted above, with each cycle of the punch 106, a media reference surface 82 is formed having the curved leading edge 86 and the curved trailing edge 88. The receptacle 112 captures the completed media reference surfaces 82 that are suited for use in flexible data storage cards 20 (FIG. 1). However, for various manufacturing reasons, a post process, or secondary process, can also be employed where the completed media reference surfaces 82 are further refined to meet the needs of various end users. For example, in one embodiment, the curved leading edge 86 is cold formed in a post process utilizing a second tooling station (not shown). Cold forming is a method of stamping a metal, such as the media reference surface 82, whereby a “coin” finish having reproducible surface features is imparted to a portion thereof, for example, the leading edge 86. The coin finishing of the leading edge 86 results in a very smooth transition between the leading edge 86 and the optically smooth surface 84. As an example, if the gap 110 exhibits a spacing variation during processing, the curved edges 86, 88 might also exhibit variations in their radius of curvature. In this case, the curved edges 86, 88 can be coin finished in a refining post process step.

In another embodiment of a post process, an added step is employed that deposits an adhesive to the attachment surface 94. In one embodiment, the adhesive is an adhesive tape approximately 0.001 inch thick. In still another embodiment, the adhesive is an ultra violet (UV) cured adhesive applied to the attachment surface 94.

The processing technique associated with FIG. 5 does not require hand polishing and results in the optically smooth surface 84 having an average surface roughness Rₐ not greater than 8 micro-inch and the curved leading edge 86 has a radius of curvature in the range of 0.001-0.007 inch. In a further embodiment, the processing technique results in the optically smooth surface 84 having an average surface roughness Rₐ not greater than 5 micro-inch. In another embodiment, the optically smooth surface 84 has an average surface roughness Rₐ in the range of 0.5-4 micro-inch. In another embodiment, the optically smooth surface 84 has an average surface roughness Rₐ not greater than 1 micro-inch. In another embodiment, the processing technique results in the curved trailing edge 88 having a radius of curvature in the range of 0.001-0.007 inch.

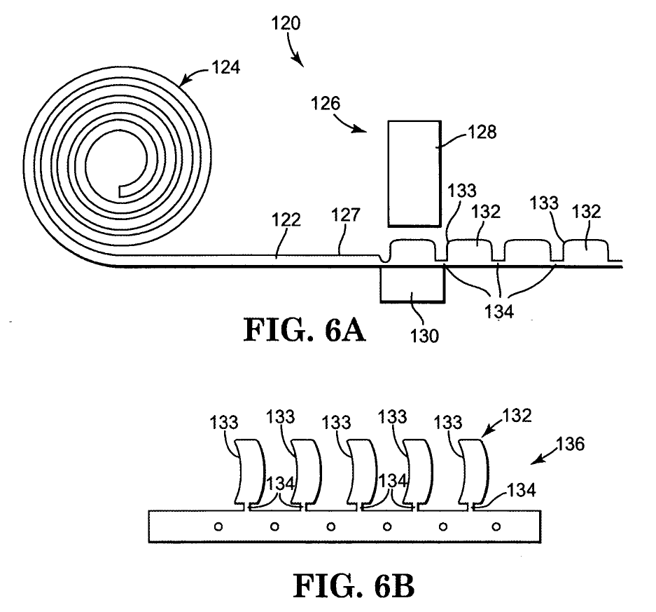

Another embodiment of a method of manufacturing a media reference surface in accordance with the present invention is illustrated in cross-section at 120 in FIG. 6A. Metal sheeting 122 is provided in the form of a coil 124 and fed into a forming apparatus 126. In a preferred embodiment, the metal sheeting 122 is provided with an optically smooth surface 127 having an average surface roughness of not greater than 8 micro-inch. The forming apparatus 126 includes a punch 128 and a die 130. The metal sheeting 122 is uncoiled and indexed into the forming apparatus 126 and processed into a plurality of media reference surfaces 132. During formation, each media reference surface 132 is configured to have a leading edge 133 that is curved, positioned adjacent the optically smooth surface 127. In a preferred embodiment, the curved leading edge 133 has a radius of curvature in the range of 0.001-0.007 inch. Regardless, no hand polishing is required to form the desired media reference surfaces 132.

FIG. 6B is a perspective view of a processed strip 136 of the media reference surface 132. In this form, the plurality of media reference surfaces 132 are conjoined by attachment edges 134 and assembled into the processed strip 136 of media reference surfaces 132. The processed strip 136 is suited for convenient delivery/deposition of the media reference surfaces 132 into flexible data storage cards 20 (FIG. 1) after the attachment edges 134 are severed, or for subsequent post processing.

In a specific example of employing the attachment edges 134 in an assembly operation, it should be noted that as depicted in FIG. 6B the attachment edges 134 are positioned so as not to interfere with the optically smooth surface 127 or the curved leading edge 133. For example, in a preferred embodiment, the media reference surface 132 has a thickness of approximately 0.007 inch and the attachment edges 134 have a thickness of approximately 0.003 inch and are positioned opposite (i.e., away from) the optically smooth surface 127 and the curved leading edge 133 (FIG. 6A). The attachment edges 134 are configured to be severed, or broken off, resulting in a separate media reference surface 132 that is suited for attachment to the interior surface 36 of the card top 30 (FIG. 2). For example, the processed strip 136 of media reference surfaces 132 can be delivered into an assembly apparatus (not shown). During assembly, the attachment edges 134 are severed, leaving the separate media reference surface 132 readied for attachment to the card top 30. As the attachment edges 134 are broken off, the optically smooth surface 127 and the curved leading edge 133 are not affected. That is to say, the optically smooth surface 127 continues to exhibit an average surface roughness of not greater than 8 micro-inch and the curved leading edge 133 has a radius of curvature in the range of 0.001-0.007 inch, and no hand polishing steps are required.

In another embodiment, the processed strip 136 of conjoined media reference surfaces 132 is subsequently post processed. In particular, in a preferred embodiment, the processed strip 136 is introduced into electro-polishing equipment, for example, an electro-polishing bath, to polish and refine the curved leading edge 133. In this regard, the media reference surfaces 132 are conjoined by the attachment edges 134 such that each of the curved leading edges 133 is polished a like amount in the electro-polishing bath. After the desired amount of electro-polishing, the processed strip 136 is removed for subsequent separation and assembly of each individual media reference surface 132 to the card top 30 (FIG. 2). In one preferred embodiment, the electro-polishing equipment is an aqueous sonic bath.

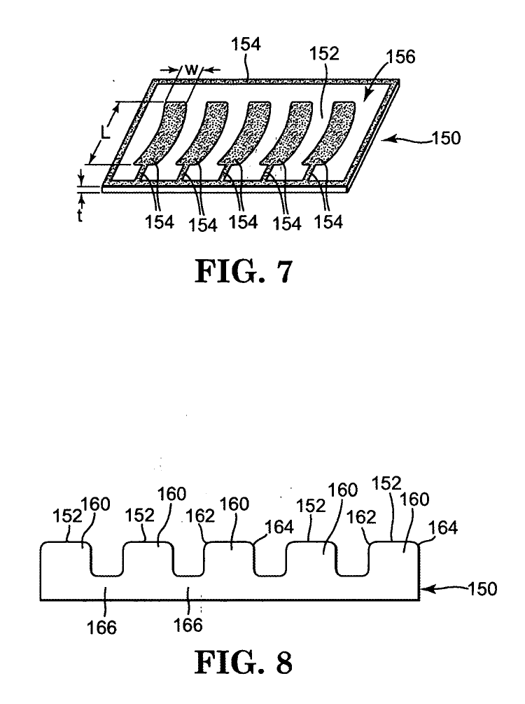

Yet another alternate method of processing a metal sheet 150 into a plurality of media reference surfaces in accordance with the present invention is illustrated in FIG. 7. The metal sheet 150 is configured to provide an optically smooth surface 152 having masked off portions 154 arranged in an array, for example. In one embodiment, the metal sheeting 150 has a thickness t of approximately 0.007 inch, corresponding to a desired thickness of the media reference surfaces to be formed. The shape of the masked off portions 154 is selected to represent the desired finished shape of what is to become a media reference surface. In one embodiment, the masked off portions 154 have a length L of approximately 0.30 inch to 0.70 inch, more preferably the length L is 0.40 inch to 0.60 inch, and most preferably, the length L is approximately 0.53 inch, and a width W of approximately 0.050 inch to 0.250 inch, more preferably the width W has a range of between 0.075 inch to 0.175 inch, and most preferably, the width W is approximately 0.10 inch. In this regard, the masked off portions 154 cover and protect the optically smooth surface 152 in preparation of a photo-etching process. Prior to introduction to the photo-etching process, the optically smooth surface 152 is coated (or covered) by the masked off portions 154. During the photo-etching process, the masked off portions 154 protect and preserve the optically smooth surface 152, and an unmasked portion 156 is etched away (or ablated). That is to say, that the unmasked portion 156 is removed via etching and the optically smooth surface 152 is maintained wherever the masked off portions 154 are present. FIG. 8 is a cross-sectional view of the metal sheeting 150 after the photo-etching process. As illustrated in FIG. 8, the masked off portions 154 (FIG. 7) have been taken off exposing a plurality of media reference surfaces 160 each having the optically smooth surface 152, a rounded leading edge 162, and a rounded trailing edge 164. The photo-etching process as described is typified by rounded edges, for example, edges 162 and 164, where the etching process occurs. Hence, the photo-etching process inherently produces the rounded leading edge 162 on the media reference surface 160. The duration of the immersion into the bath is controlled such that the unmasked portion 156 is sufficiently etched away, rounding edges 162, 164 and leaving an attachment edge 166 between each media reference surface 160.

As illustrated in FIG. 8, after completion of the photo-etching process, the media reference surfaces 160 are configured for separation and attachment to card tops 30 (FIG. 2). In one embodiment, the media reference surfaces 160 are characterized by the optically smooth surface 152 having an average surface roughness of not greater than 8 micro-inch, for example, approximately 1.0 micro-inch, and the curved leading edge 162 having a radius of curvature in the range of 0.001-0.007 inch, for example, approximately 0.004 inch. Again, hand polishing is not required to produce the desired media reference surfaces 160.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A method of manufacturing media reference surfaces for use in a flexible data storage card comprising:
providing a metal sheet having a first side and a second side, at least one side having an optically smooth surface characterized by an average surface roughness not greater than 8 micro-inch; and
processing the metal sheet into a plurality of media reference surfaces, each media reference surface characterized by having at least one curved edge adjacent the optically smooth surface;
wherein the step of processing the metal sheet is characterized by an absence of hand polishing.

2. The method of claim 1, wherein providing a metal sheet includes providing a metal sheet wherein the optically smooth surface is characterized by an average surface roughness not greater than 4 micro-inch.

3. The method of claim 1, wherein providing a metal sheet includes providing a metal sheet wherein the optically smooth surface is characterized by an average surface roughness in the range of 0.5 to 4 micro-inch.

4. The method of claim 1, wherein providing a metal sheet includes providing a metal sheet wherein the optically smooth surface is characterized by an average surface roughness not greater than 1 micro-inch.

5. The method of claim 1, wherein the step of processing the metal sheet provides the at least one curved edge with a radius of curvature in the range of 0.001 to 0.007 inch.

6. The method of claim 5, wherein the curved edge is a leading edge of the media reference surface.

7. The method of claim 1, wherein the step of processing the metal sheet includes shearing the metal sheet with a die and a punch to form the plurality of media reference surfaces.

8. The method of claim 7, wherein shearing the metal sheet includes die rolling the at least one edge.

9. The method of claim 7, wherein shearing the metal sheet includes providing a gap between the die and the punch.

10. The method of claim 9, wherein providing a gap includes providing a gap having a spacing between 0.005 inch and 0.0001 inch.

11. The method of claim 1, wherein the step of processing the metal sheet into the plurality of media reference surfaces includes cold forming the metal sheet.

12. The method of claim 11, wherein cold forming includes coin finishing.

13. The method of claim 1, wherein the step of processing the metal sheet into the plurality of media reference surfaces includes photo-etching.

14. The method of claim 1, wherein processing the metal sheet into the plurality of media reference surfaces includes processing the metal sheet into a plurality of head zero components.

15. The method of claim 1, wherein providing the metal sheet includes providing an elongate metal sheet having a length that is greater than a width of the metal sheet by a factor of approximately 10.

16. The method of claim 1, wherein providing the metal sheet includes providing a coiled roll of metal sheeting.

17. The method of claim 16, wherein providing the coiled roll of metal sheeting includes providing a coiled roll of metal sheeting having a protective coating in contact with the optically smooth surface.

18. The method of claim 1, wherein the step of processing the metal sheet includes leaving at least one attachment edge on each of the plurality of media reference surfaces such that adjacent media reference surfaces are conjoined.

19. The method of claim 18, further comprising:
severing the conjoined media reference surfaces; and
disposing an individual media reference surface into a flexible data storage card.

20. The method of claim 18, further comprising post-processing the conjoined media reference surfaces.

21. The method of claim 20, wherein the post-processing includes electro-polishing the conjoined media reference surfaces.

22. The method of claim 1, wherein the media reference surfaces are configured for use in a StorCard® flexible data storage card.

23. A method of manufacturing media reference surfaces for use in a flexible data storage card comprising:
providing a length of metal sheeting, the metal sheeting having a first side and a second side, at least one side providing an optically smooth surface;
shearing the metal sheeting with a die and a punch to form the media reference surfaces, each media reference surface having a leading edge and a trailing edge;
wherein the shearing is configured to die roll at least the leading edge.

24. The method of claim 23, wherein the step of shearing the metal sheeting imparts a radius of curvature to the leading edge in the range of 0.001 to 0.007 inch.

25. The method of claim 23, wherein the step of shearing the metal sheeting imparts a radius curvature to the trailing edge in the range of 0.001 to 0.007 inch.

26. The method of claim 23, wherein the step of shearing the metal sheeting includes providing a gap between the die and the punch.

27. The method of claim 26, wherein providing the gap includes providing a gap having a spacing between 0.005 inch and 0.0001 inch.

28. The method of claim 23, wherein the optically smooth surface has an average surface roughness not greater than 8 micro-inch.

29. The method of claim 23, wherein the step of shearing the metal sheets causes each media reference surface to experience a mechanical yield at the leading edge prior to a mechanical fracture at the leading edge.

30. The method of claim 23, further comprising cold forming the leading edge.

31. The method of claim 30, wherein cold forming includes coin finishing the leading edge.

32. The method of claim 23, further comprising electro-polishing the leading edge.
